(19) United States
(12) Patent Application Publication
(10) Pub. No.: US 2023/0153901 A1
(43) Pub. Date: May 18, 2023

(54) SYSTEMS AND METHODS FOR LIQUIDITY BLENDING

(71) Applicant: JPMORGAN CHASE BANK, N.A., New York, NY (US)

(72) Inventors: Dominic J RYAN, Surrey (GB); Ilya TRUBOV, London (GB)

(21) Appl. No.: 17/525,259

(22) Filed: Nov. 12, 2021

(51) Int. Cl. G06Q 40/04; G06Q 40/06

(52) U.S. Cl. CPC G06Q 40/04; G06Q 40/06

(57) ABSTRACT

Systems and methods for liquidity blending are disclosed. In one embodiment, a method for liquidity blending may include: receiving, by a liquidity blending computer program, a client trade inquiry; determining, by the liquidity blending computer program, that the client trade inquiry passes pre-negotiation checks; determining, the liquidity blending computer program, that liquidity blending is applicable to the client inquiry; receiving, by the liquidity blending computer program, price updates from a plurality of algorithms and/or a trader pricer; determining, by the liquidity blending computer program, that the prices from the plurality of algorithms and/or the trader pricer pass preemptive price checks; blending, by the liquidity blending computer program, the price levels into a blended price quote; determining, by the liquidity blending computer program, that the blended price quote passes a regulatory control; and sending, by the liquidity blending computer program, the blended price quote to the client.

### BACKGROUND OF THE INVENTION

### 1. Field of the Invention

Embodiments relate generally to systems and methods for liquidity blending.

### 2. Description of the Related Art

The prices of financial products change frequently, sometime several times per second. Due to this speed, it is not feasible for a human trader to incorporate multiple prices from different liquidity providers and compute a weighted average price fast enough to be competitive in electronic markets.

In addition, trading algorithms are limited by their liquidity. In other words, if an algorithm does not have sufficient liquidity, it cannot participate in a trade.

### SUMMARY OF THE INVENTION

Systems and methods for liquidity blending are disclosed. According to an embodiment, a method for liquidity blending may include: (1) receiving, by a liquidity blending computer program, a request for quote from a client; (2) receiving, by the liquidity blending computer program, a plurality of price levels; (3) determining, by the liquidity blending computer program, that the price levels pass pre-emptive price checks; (4) inserting, by the liquidity blending computer program, the plurality of price levels into a table, wherein rows in the table are sorted from a least expensive price level to a most expensive price level; (5) blending, by the liquidity blending computer program, a subset of the plurality of price levels into a blended price quote by summing the price levels in the table starting with the least expensive price level until the sum of the price levels satisfies the request for quote; (6) determining, by the liquidity blending computer program, that the blended price quote passes a regulatory control; and (7) sending, by the liquidity blending computer program, the blended price quote to the client.

In one embodiment, the method may further include determining, by the liquidity blending computer program, that the request for quote passes pre-negotiation checks.

In one embodiment, the pre-negotiation checks may include a check on a client account and a check on a source of the request for quote.

In one embodiment, the plurality of price levels may be received from a plurality of algorithms and/or a trader pricer.

In one embodiment, the method may further include determining, by the liquidity blending computer program, that liquidity blending is applicable to the request for quote. In one embodiment, the liquidity blending computer program may apply a plurality of rules selected from the group consisting of a currency, a size of the request for quote, a product type, a risk, a tenor, and/or a number of legs. The rules may be retrieved from a table of rules, and the liquidity blending computer program applies the rules in order of specificity.

In one embodiment, the pre-emptive price check may include a price collar check and/or a trading limit check.

In one embodiment, the blended price quote may include a weighted average of the subset of price levels.

According to another embodiment, a method for liquidity blending may include: (1) receiving, by a liquidity blending computer program, an order from a client; (2) receiving, by the liquidity blending computer program, a plurality of price levels; (3) determining, by the liquidity blending computer program, that the price levels pass pre-emptive price checks; (4) inserting, by the liquidity blending computer program, the plurality of price levels into a table, wherein rows in the table are sorted from a least expensive price level to a most expensive price level; (5) blending, by the liquidity blending computer program, a subset of the plurality of price levels into a blended order by summing the price levels in the table starting with the least expensive price level until the sum of the price levels satisfies the order; (6) determining, by the liquidity blending computer program, that the blended order passes a regulatory control; and (7) sending, by the liquidity blending computer program, the blended order to a trading system.

In one embodiment, the method may further include determining, by the liquidity blending computer program, that the order passes pre-negotiation checks.

In one embodiment, the pre-negotiation checks may include a check on a client account and a check on a source of the order.

In one embodiment, the plurality of price levels may be received from a plurality of algorithms and/or a trader pricer.

In one embodiment, the method may further include determining, by the liquidity blending computer program, that liquidity blending is applicable to the order. The liquidity blending computer program may apply a plurality of rules selected from the group consisting of a currency, a size of the order, a product type, a risk, a tenor, and/or a number of legs. The rules may be applied in order of specificity.

In one embodiment, the pre-emptive price check may include a price collar check and/or a trading limit check.

In one embodiment, the blended order may include a weighted average of the subset of price levels.

According to another embodiment, an electronic device may include a memory storing a liquidity blending computer program and a computer processor. When executed by the computer processor, the liquidity blending computer program causes the computer processor to: receive a request for quote or an order from a client; receive a plurality of price levels; determine that the price levels pass pre-emptive price checks; insert the plurality of price levels into a table, wherein rows in the table are sorted from a least expensive price level to a most expensive price level; blend a subset of the plurality of price levels into a blended price quote or a blended order by summing the price levels in the table starting with the least expensive price level until the sum of the price levels satisfies the request for quote or the order; determine that the blended price quote or the blended order passes a regulatory control; and sending, by the liquidity blending computer program, the blended price quote to the client or the blended order to a trading system.

In one embodiment, the liquidity blending computer program may further cause the computer processor to determine that liquidity blending is applicable to the request for quote or the order by applying a plurality of rules selected from the group consisting of a currency, a size of the request for quote or the order, a product type, a risk, a tenor, and/or a number of legs, the rules may be retrieved from a table of rules, and the liquidity blending computer program may apply the rules in order of specificity.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for liquidity blending according to an embodiment;

FIG. 2 depicts a method for request for quote liquidity blending according to an embodiment;

FIG. 3 depicts a method for order liquidity blending according to an embodiment; and

FIG. 4 depicts an exemplary trader user interface according to an embodiment.

### DETAILED DESCRIPTION OF PREFERRED EMBODIMENTS

Embodiments relate generally to systems and methods for liquidity blending.

In embodiments, blended liquidity quoting allows traders and algorithms to collaborate in pricing client requests-for-quote (“RFQ”) inquiries within trading systems even if they do not have sufficient liquidity. Rather than a client RFQ being routed to a trading desk or an algorithm, both the trading desk and the algorithm quote the RFQ. Both provide prices, and the trading system may return the weighted average of the prices to the client. This results in the client being provided with the best available price.

In addition, liquidity blending allows algorithms to participate in client trading even if the algorithms do not have sufficient liquidity or trading limits to fulfil the full size of the client inquiry. This is because the trading desk may pick up any risk beyond what the algorithm can accept. Embodiments may further provide a mechanism to incorporate new algorithm strategies that may start out with relatively low trading limits.

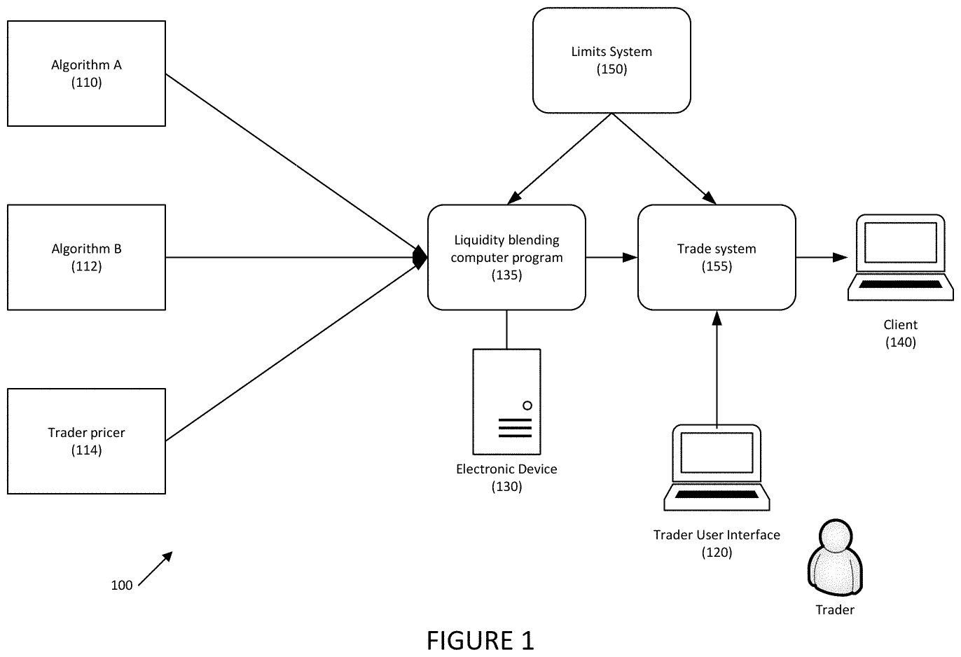

Referring to FIG. 1, a system for liquidity blending is disclosed according to one embodiment. System 100 may include a plurality of algorithms (e.g., algorithm A 110, algorithm B 112, etc.), trader pricer 114, trader user interface 120, electronic device 130 executing liquidity blending computer program 135, and client 140.

Algorithm A 110 and Algorithm B 112 may be any suitable trading algorithm, and each algorithm 110 and 112 may have liquidity and/or trading limits. Although two algorithms are illustrated in FIG. 1, it should be recognized that additional algorithms or fewer algorithms may be provided as is necessary and/or desired.

Algorithms 110, 112 may employ various methods to determine a price for a financial product. Algorithms 110, 112 may produce their initial price quickly and then update the prices throughout the life of the client inquiry. In embodiments, algorithms 110, 112 may provide some price data to liquidity blending computer program 135. This provides client 140 with a fast response to its quote request and ensures that the price is up to date with respect to external markets, where prices continuously fluctuate.

Algorithms 110, 112 may be run as separate systems that liquidity blending computer program 135 may interact with.

The liquidity available from each algorithm 110, 112 may be determined by how much liquidity each algorithm 110, 112 is able to source from internal and external markets.

In embodiments, limits may be set by the creators of algorithms 110, 112, traders, members of an organization's controls groups, etc. For example, the controls group may oversee limits decisions, and may provide limits to limits system 150. Limits system 150 may provide the controls and limits to liquidity blending computer program 135 and/or trade system 155.

Trader pricer 114 may be a computer program that may determine a price of one or more financial products using a different approach than that taken by algorithms 110, 112. For example, trader pricer 114 may determine a mid, or fair value, for the financial products and may combine that value with a pre-defined trader bid/offer spread. Using trader user interface 120, traders may take this price into consideration while making their quote decisions, but are still able to manually adjust the suggested price from trader pricer 114.

Trader pricer 114 may provide a stream of raids that update every time that the underlying market data changes (e.g., the mid “ticks”). A trader can manually quote an RFQ as the calculation of the mid and a trader defined spread, and then each time the Trader Pricer updates the mid, the trader will recalculate the new mid combined with the trader defined spread price so the system can update the quote that the client sees.

Trader user interface 120 may provide traders information about the client inquiry, including client name, product, size of inquiry, etc. Trader user interface 120 may provide traders with price details from trader pricer 114 and algorithms 110 and/or 112. Using trader user interface 120, traders may override suggested prices from trader pricer 114. Trader user interface 120 may further notify the trader if an inquiry results in trade system 155 executing a trade with client 140. As used herein, a trading desk is one or more traders. Each trader has its own instance of trader user interface 120.

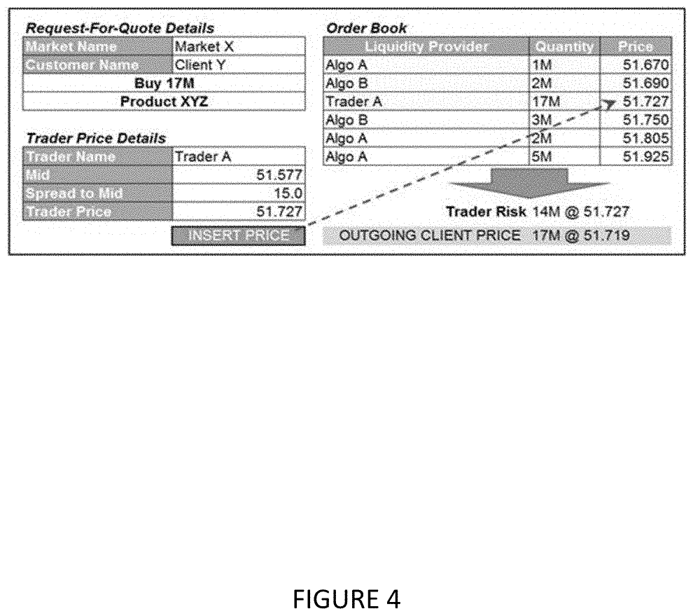

An example of information that trader user interface 120 may provide is provided in FIG. 4.

The trading desk may apply pre-configured rules that specify whether an incoming RFQ should use prices from trader pricer 114 in the blended order book. For example, if the RFQ is under a maximum size specified in the pre-configured rules, and the instrument is in a pre-defined group of instruments, the trading desk may then use prices from trader pricer 114. If, however, a similar RFQ arrives with a size that is greater than the maximum size specified in the pre-configured rules, the prices from trader pricer 114 will not be automatically added to the order book. The trader may instead manually add the price stream using, for example, a button on trader user interface 120. The button click is processed by trade system 155 which, in turn, updates liquidity blending computer program 135. An example of the button is the “Insert Price” button in FIG. 4.

The new price may then be sent to liquidity blending computer program 135 via trade system 155. Once Liquidity Blending computer program 135 has the trader's overridden price, it may then add the price into the order book, produce a new blended price (e.g., a new weighted average price), and may then send the price to client 140 via trade system 155.

In embodiment, trader user interface 120 may be a lightweight client that allows traders to see inquiry information on their screen and for traders to interact with RFQs through button clicks. Key logic may be performed by back end components such as trade system 155, liquidity blending computer program 135, trader pricer 114, etc.

In one embodiment, electronic device 130 may be any suitable electronic device, including servers (e.g., physical and/or cloud-based), computers (e.g., workstations, desktops, laptops, notebooks, tablets, etc.), etc.

Based on controls and limits specified in limits system 150, liquidity blending computer program 135 may apply pre-emptive price checks, and trade system 155 may apply regulatory controls. In embodiments, the controls applied by trade system 155 are the official, audited controls.

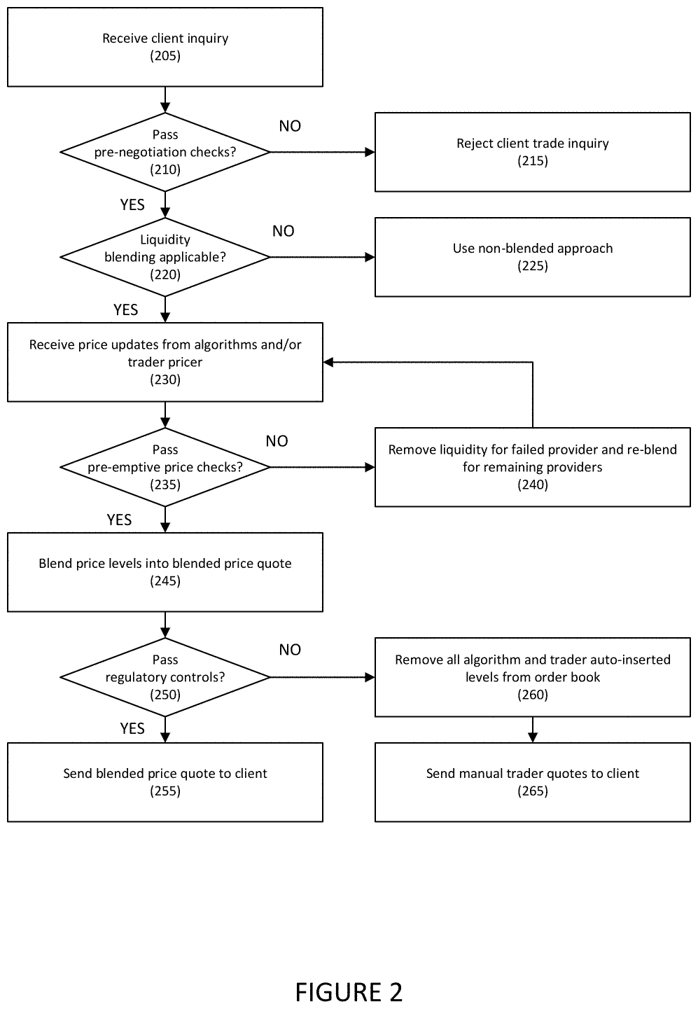

Referring to FIG. 2, a method for liquidity blending for request for quotes is disclosed according to an embodiment.

In step 205, a liquidity blending computer program may receive a client inquiry. The client inquiry may be a Request for Quote.

In step 210, the liquidity blending computer program may review the client trade inquiry to determine if the client trade inquiry passes pre-negotiation checks. If the client trade inquiry does not pass pre-negotiation checks, in step 215, the client inquiry may be rejected. For example, if the trade system does not recognize the client's account, it will not allow the client to conduct a trade. If the RFQ is sent from an execution venue that is incorrect, the inquiry may be rejected. Other pre-negotiation checks may be performed as is necessary and/or desired.

If the client trade inquiry passes the pre-negotiation checks, in step 220, the liquidity blending computer program may determine if liquidity blending is applicable to the client trade inquiry. For example, the liquidity blending computer program may apply trader rules that define how inquiries are to be handled. For example, the rules may include various criteria that the liquidity blending computer program may match against the inquiry, such as currency, size of the inquiry, product type, risk, tenor, number of legs, etc.

In embodiments, traders may add, edit, view, and/or delete rules from a trader user interface. Each rule may be represented as a row in a table of rules, and each row may include rule criteria. Rules with more criteria are more specific rules. A rule with no criteria specified is the most general and matches all RFQs and orders.

Rules may be arranged with the most specific rules at the top and the most general rules at the bottom of the table. When an inquiry is received, it may be evaluated against the routing rules one at a time starting with the top rule, the first rule to match the inquiry is used.

If liquidity blending is not applicable, in step 225, a non-blended approach may be used.

If liquidity blending is applicable, in step 230, the liquidity blending computer program may receive zero or more price levels from a plurality of algorithms and/or a trader pricer. Each price level may include a price and the quantity that the algorithm has available at that price. Price levels may be represented visually as one row each in the order book table as depicted, for example, in FIG. 4.

In step 235, the liquidity blending computer program may determine whether the price levels from the algorithm(s) and the trader pricer pass pre-emptive price checks. The pre-emptive price checks may include, for example, a price collar check that ensures that the price is close to an independent reference point, trading limit check (e.g., size, risk, etc.), etc. The pre-checks may be very similar to the regulatory checks which are performed after the blending process. By running them early, invalid price levels may be removed from the order book while allowing valid price levels to precede and be sent to the client.

If the price levels from each provider does not pass the checks, in step 240, the liquidity for the failed the algorithm(s) or the trader pricer may be removed, and the process may return to step 230.

If the pre-emptive price checks pass, in step 245, the price levels may be blended into a blended price quote. In one embodiment, price levels in the order book may be sorted with the least expensive price levels (from the client's perspective) at the top. The liquidity blending computer program may take the top price level (i.e., the least expensive price level) and add each subsequent price level until enough price levels have been summed to fulfil the size of the client inquiry. If the sum of the price levels exceeds the client inquiry size, the last selected level may only be partly used.

Once enough levels are selected, the liquidity blending computer program may perform a weighted average of the price levels. The weighting of each level is based on its ratio with respect to the client inquiry size.

In step 250, the liquidity blending computer program may check to see if the blended price quote passes regulatory controls. Example checks may include price collar checks, trading limit checks, etc. The regulatory controls may be based on regulations applicable to the products and jurisdictions for the trade. If it does not, in step 260, all algorithm and trader auto-inserted levels may be removed from the order book, and in step 265, manual trader quotes may be provided to the client.

If the liquidity blending computer program determines that the blended price quote passes regulatory controls, in step 255, the liquidity blending computer program may send the blended quote to the client.

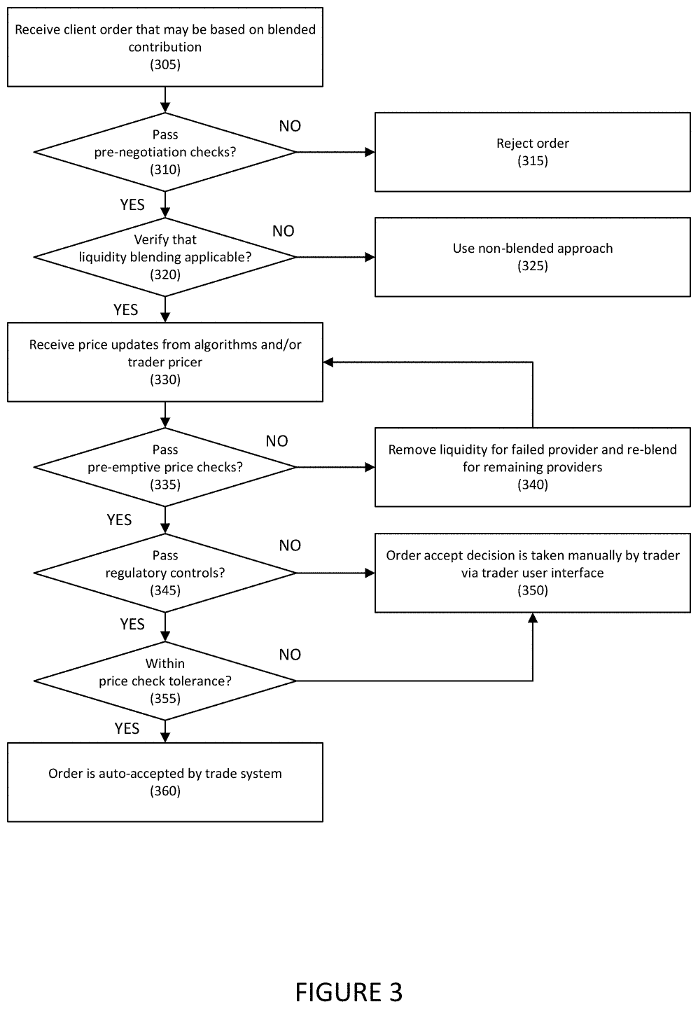

Referring to FIG. 3, a method for order liquidity blending is disclosed according to an embodiment.

In step 305, a liquidity blending computer program may receive an order from a client. The order may be based on a blended contribution. In one embodiment, the blending may be performed using a process similar to step 245, above.

In step 310, the liquidity blending computer program may review the order to determine if it passes pre-negotiation checks. These pre-negotiation checks may be similar to those in step 210, above. If the order does not pass passes pre-negotiation checks, in step 315, the order may be rejected.

If the order passes the pre-negotiation checks, in step 320, the liquidity blending computer program may verify that liquidity blending is applicable to the order. This may be similar to step 220, above.

If liquidity blending is verified, in step 325, a non-blended approach may be used.

If liquidity blending is verified, in step 330, the liquidity blending computer program may receive zero or more price levels from a plurality of algorithms and/or a trader pricer. This may be similar to step 230, above.

In step 335, the liquidity blending computer program may determine whether the price levels from the algorithm(s) and the trader pricer pass pre-emptive price checks. The pre-emptive price checks may be similar to those in step 235, above.

If the price levels from each provider does not pass the checks, in step 340, the liquidity for the failed the algorithm(s) or the trader pricer may be removed.

If the pre-emptive price checks pass, in step 345, the liquidity blending computer program may check to see if the blended order passes regulatory controls. The checks may be similar to those in step 250, above.

If the order does not pass regulatory controls, in step 360, the order accept decision may be taken manually by trader via trader user interface.

If the liquidity blending computer program determines that the order passes regulatory controls, in step 355, the order be checked for being within one or more price check tolerances, such as a price collar, a profit and loss check, etc. If the price check, profit and loss check, etc. are within a certain tolerance, in step 360, the trade maybe executed.

For example, if the order book was updated in step 340 to remove a liquidity provider, the actual blended price may differ from that in the client's blended order by more than the tolerance check. This may result in the order being accepted manually in step 350.

As another example, if all liquidity is removed from the order book and a new blended price cannot be computed, then the tolerance check will fail and the order may be accepted manually.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programming logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for liquidity blending, comprising:
receiving, by a liquidity blending computer program, a request for quote from a client;
determining, by the liquidity blending computer program, that the request for quote passes pre-negotiation checks;
in response to the determination that the request for quote passes pre-negotiation checks, receiving, by the liquidity blending computer program, a plurality of price levels;
determining, by the liquidity blending computer program, that the price levels pass pre-emptive price checks;
inserting, by the liquidity blending computer program, the plurality of price levels into a table, wherein rows in the table are sorted from a least expensive price level to a most expensive price level;
blending, by the liquidity blending computer program, a subset of the plurality of price levels into a blended price quote by summing the price levels in the table starting with the least expensive price level until the sum of the price levels fulfills a size of the request for quote;
determining, by the liquidity blending computer program, that the blended price quote passes a regulatory control; and
sending, by the liquidity blending computer program, the blended price quote to the client.

2. (canceled)

3. The method of claim 1, wherein the pre-negotiation checks comprise a check on a client account and a check on a source of the request for quote.

4. The method of claim 1, wherein the plurality of price levels are received from a plurality of algorithms and/or a trader pricer.

5. The method of claim 1, further comprising:
determining, by the liquidity blending computer program, that liquidity blending is applicable to the request for quote.

6. The method of claim 5, wherein the liquidity blending computer program determines that liquidity blending is applicable to the request for quote by applying a plurality of rules, each of the plurality of rules based on a number of criteria selected from the group consisting of a currency, the size of the request for quote, a product type, a risk, a tenor, and/or a number of legs.

7. The method of claim 6, wherein the rules are retrieved from a table of rules, and the liquidity blending computer program applies the rules in descending order of the number of criteria on which each of the plurality of rules is based.

8. The method of claim 1, wherein the pre-emptive price check comprises a price collar check and/or a trading limit check.

9. The method of claim 1, wherein the blended price quote comprises a weighted average of the subset of price levels.

10. A method for liquidity blending, comprising:
receiving, by a liquidity blending computer program, an order from a client;
determining, by the liquidity blending computer program, that the order passes pre-negotiation checks;
in response to the determination that the order passes pre-negotiation checks, receiving, by the liquidity blending computer program, a plurality of price levels;
determining, by the liquidity blending computer program, that the price levels pass pre-emptive price checks;
inserting, by the liquidity blending computer program, the plurality of price levels into a table, wherein rows in the table are sorted from a least expensive price level to a most expensive price level;
blending, by the liquidity blending computer program, a subset of the plurality of price levels into a blended order by summing the price levels in the table starting with the least expensive price level until the sum of the price levels fulfills a size of the order;
determining, by the liquidity blending computer program, that the blended order passes a regulatory control; and
sending, by the liquidity blending computer program, the blended order to a trading system.

11. (canceled)

12. The method of claim 10, wherein the pre-negotiation checks comprise a check on a client account and a check on a source of the order.

13. The method of claim 10, wherein the plurality of price levels are received from a plurality of algorithms and/or a trader pricer.

14. The method of claim 10, further comprising:
determining, by the liquidity blending computer program, that liquidity blending is applicable to the order.

15. The method of claim 14, wherein the liquidity blending computer program determines that liquidity blending is applicable to the order by applying a plurality of rules, each of the plurality of rules based on a number of criteria selected from the group consisting of a currency, the size of the order, a product type, a risk, a tenor, and/or a number of legs.

16. The method of claim 15, wherein the rules are retrieved from a table of rules, and the liquidity blending computer program applies the rules in descending order of the number of criteria on which each of the plurality of rules is based.

17. The method of claim 10, wherein the pre-emptive price check comprises a price collar check and/or a trading limit check.

18. The method of claim 10, wherein the blended order comprises a weighted average of the subset of price levels.

19. An electronic device comprising:
a memory storing a liquidity blending computer program; and
a computer processor;
wherein, when executed by the computer processor, the liquidity blending computer program causes the computer processor to:
receive a request for quote or an order from a client;
determine that the request for quote or the order passes pre-negotiation checks;
in response to the determination that the request for quote or the order passes pre-negotiation checks, receive a plurality of price levels;
determine that the price levels pass pre-emptive price checks;
insert the plurality of price levels into a table, wherein rows in the table are sorted from a least expensive price level to a most expensive price level;
blend a subset of the plurality of price levels into a blended price quote or a blended order by summing the price levels in the table starting with the least expensive price level until the sum of the price levels fulfills a size of the request for quote or the order;
determine that the blended price quote or the blended order passes a regulatory control; and
sending, by the liquidity blending computer program, the blended price quote to the client or the blended order to a trading system.

20. The electronic device of claim 19, wherein the liquidity blending computer program further cause the computer processor to determine that liquidity blending is applicable to the request for quote or the order by applying a plurality of rules, each of the plurality of rules based on a number of criteria selected from the group consisting of a currency, the size of the request for quote or the order, a product type, a risk, a tenor, and/or a number of legs, wherein the rules are retrieved from a table of rules, and the liquidity blending computer program applies the rules in descending order of the number of criteria on which each of the plurality of rules is based.
